(19) United States
(12) Patent Application Publication
(10) Pub. No.: US 2015/0377795 A1
(43) Pub. Date: Dec. 31, 2015

(54) DEFECT DETECTION USING SURFACE ENHANCED ELECTRIC FIELD

(71) Applicant: KLA-Tencor Corporation, Milpitas, CA (US)

(72) Inventors: Guoheng Zhao, Palo Alto, CA (US); David W. Shortt, Milpitas, CA (US)

(21) Appl. No.: 14/851,887

(22) Filed: Sep. 11, 2015

Related U.S. Application Data
(63) Continuation of application No. PCT/US2014/023817, filed on Mar. 11, 2014.
(60) Provisional application No. 61/776,728, filed on Mar. 11, 2013.

(51) Int. Cl. G01N 21/94; G01N 21/88; G01N 21/95

(52) U.S. Cl. CPC G01N 21/94; G01N 21/9501; G01N 21/8806; G01N 2021/8848; G01N 2201/06113

(57) ABSTRACT

A system and method for inspecting a surface of a wafer. The system includes a source generating an optical beam at a deep ultraviolet wavelength; a solid immersion lens, receiving the optical beam, positioned such that the air gap between the lens and the wafer surface is less than the wavelength, an enhanced electric field being generated at the wafer surface, at least one particle on the wafer receiving the enhanced electric field generating scattered light; a detector receiving the scattered light and generating a corresponding electrical signal; and a processor receiving and analyzing the electrical signal.

### CROSS-REFERENCE TO RELATED APPLICATION

This application is filed under 35U.S.C. §111(a) and §365(c) as a continuation of International Patent Application No. PCT/US2014/023817, filed on Mar. 11, 2014, which application claims the benefit of U.S. Provisional Patent Application No. 61/776,728, filed on Mar. 11, 2013, which applications are incorporated herein by reference in their entireties.

### TECHNICAL FIELD

The purpose of this invention is to provide a method and system for generating an enhanced electric field on wafer surface by utilizing evanescent waves, therefore to improve detection sensitivity of particle defects on wafer surface.

### BACKGROUND

Unpatterned inspection systems are used by silicon wafer manufacturers and integrated circuit (IC) manufacturers for inspection of bare silicon wafers and wafers coated with thin films. The systems are used to detect various defects such as particles, pits, scratches, and crystal defects on wafers. They are further used to character the surface roughness by measuring haze from wafers. Dark field detection of laser scattering by particles has been the core technology of bare wafer inspection, e.g., SurfScan® bare wafer inspection tools manufactured by KLA-Tencor.

Detecting the scattered light of small particles (<<wavelength) on wafer surface illuminated by a laser beam has been a very effective technology for particle detection. However, the scattering process is inherently inefficient for detecting very small particles as the scattering efficiency drops rapidly with the decreasing size of the particles, to the power of 6 of particle diameter. Inspection speed further limits the pixel dwell time, therefore the number of scattered photons reaching detector of small particles is extremely low. Therefore there is a need to improve the particle scattering efficiency.

### SUMMARY

The invention broadly includes a system and method for detecting scattered light from particles on a wafer which have been excited by an enhanced electric field. A solid immersion lens is positioned proximate to the wafer surface. The front flat surface of the lens is parallel to the wafer surface such that an air gap is maintained. A deep ultra violet light source emits a laser beam illuminating the surface through the solid immersion lens at the critical angle (defined as the incident angle at which total internal reflection occurs) thereby generating an evanescent wave. An enhanced electric field induced by the evanescent wave is generated at the wafer surface. The air gap distance is less than the wavelength emitted by the DUV light source. The solid immersion lens is supported by a lens support. The scattered light of the particles excited by the enhanced electric field is coupled by the solid immersion lens to the far field and collected by a first and a second lens. A detector receives the collected light and generates a corresponding electrical signal. A processor receives and analyzes the detector signal.

An optional grating or coating may be applied to the solid immersion lens to improve generation of the evanescent signal.

### BRIEF DESCRIPTION OF THE DRAWINGS

In the accompanying drawings:

FIG. 1A shows the reflectance of 266 nm wavelength light incident on a Si surface at various incident angles; FIG. 1B shows the electric field intensity distribution of P polarization in the direction normal to the Si surface;

FIG. 2a shows the reflection of 266 nm wavelength light incident on Si surface when the ambient material is SiO₂; FIG. 2b shows the electric field distribution when the incident angle is 75 degrees;

FIG. 3A shows the reflectance curve when the ambient material is SiO2, having a 145 nm air gap between the ambient material and the Si surface; FIG. 3B shows the electric field distribution along the direction normal to the surface;

FIG. 4 shows a functional block diagram of the present invention;

FIG. 5 shows the field distribution for three different wavelengths of 250 nm, 260 nm, and 280 nm;

FIG. 6 shows an optional metal coating applied to the solid immersion lens shown in FIG. 4;

FIG. 7 shows an optional grating applied to the solid immersion lens shown in FIG. 4;

FIG. 8A and FIG. 8B illustrate the lens support position shown in FIG. 4 in greater detail;

FIG. 9 illustrates a flowchart according to the present invention;

### DETAILED DESCRIPTION OF THE INVENTION

Total internal reflection and scattering by evanescent waves are well-known and have found applications such as biosensors. Surface Plasmon Resonance is a well-known phenomenon that has been extensively studied for metals, e.g., Ag or Au, at visible-red wavelengths. These two concepts are often related as excitation of Surface Plasmon Wave requires illumination configuration using total internal reflection.

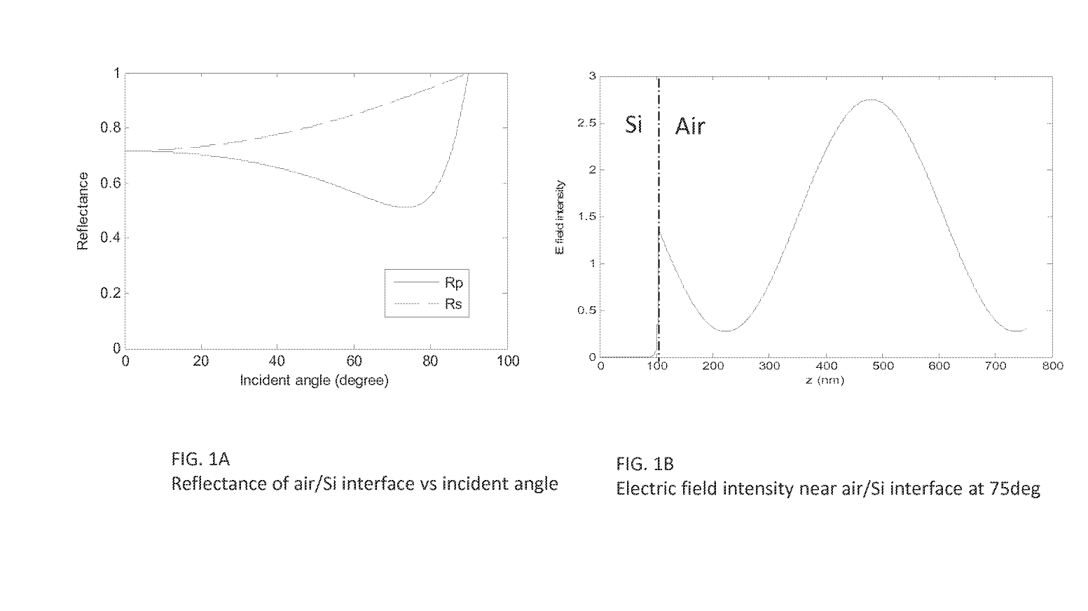

FIG. 1A shows the reflectance of 266 nm wavelength light incident on Si surface at various incident angles, and FIG. 1B shows the electric field intensity distribution of P polarization (electric field vector is parallel to the incident plane) in the direction normal to the Si surface when incident angle is 75 degrees, which is roughly an optimum angle of incidence for detecting particles on surface. This represents the configuration of one typical conventional wafer inspection. The oscillation of electric field is a result of the interference between the incident beam and the reflected beam, the position of peaks and valleys depends on the phase shift of reflected beam which is dependent on the material property, the contrast of peak to valley depends on the reflectance, and the average of peak and valley is the sum of intensity of the incident beam and the reflected beam.

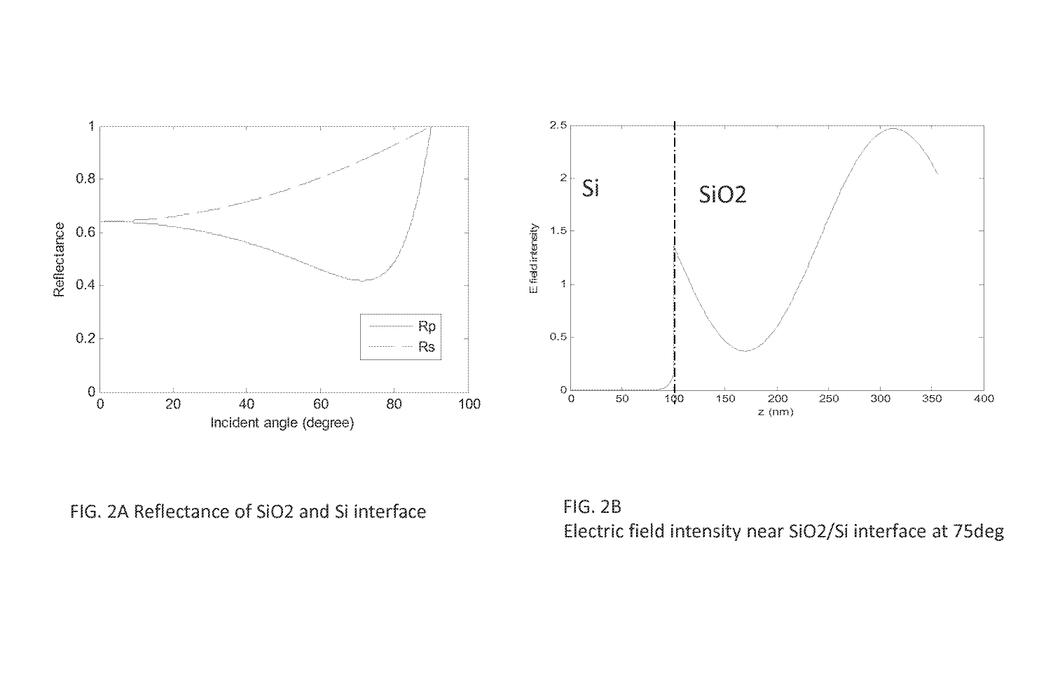

Field intensity is normalized to the incident beam. In this case, the field intensity at the surface is about equal to the sum of the incident and reflected beams. For reference, FIG. 2A shows the reflection of 266 nm light incident on Si surface when ambient material is SiO₂, a typical glass material used for deep UV wavelengths. FIG. 2B shows the electric field distribution when incident angle is 75 degrees. Again, the field intensity at Si surface is about equal to the sum of the incident and reflected beams. This is not a practical configuration for particle detection. It is shown only for comparison.

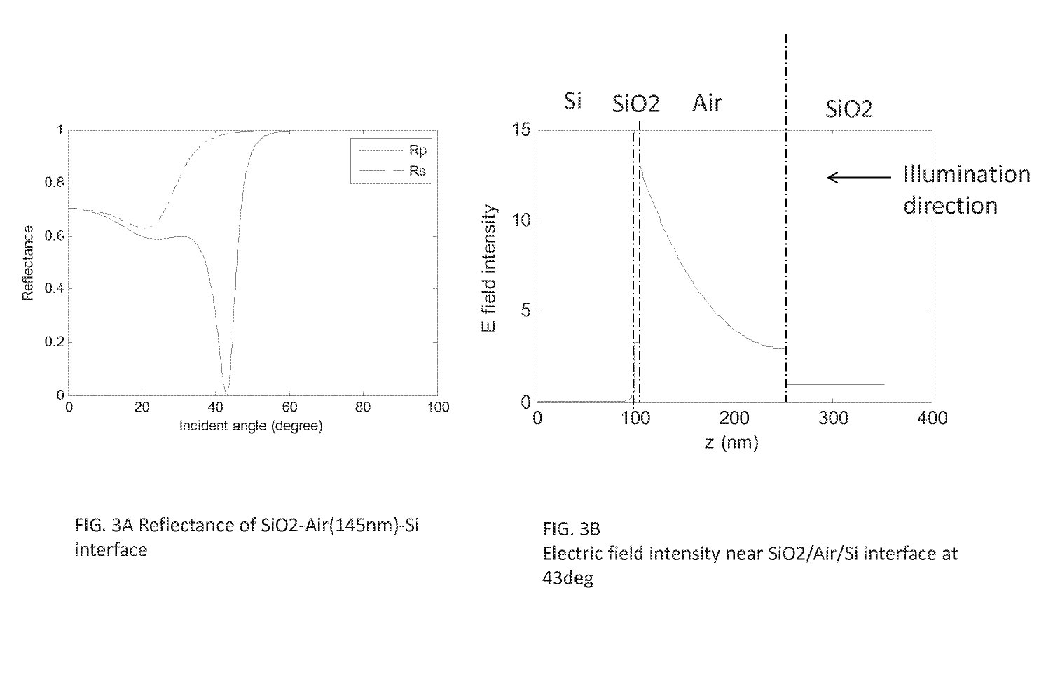

FIG. 3A shows the reflectance curve when ambient material is SiO₂ and there is about 145 nm of air gap between the ambient material and the Si surface. For P polarized light illumination, at the critical angle of SiO₂, there is a strong absorption, and the reflected light intensity drops to practically zero. FIG. 3B shows the electric field distribution along the direction normal to the surface. At the Si surface, the electric field intensity reaches a peak that is much higher than the electric field in the conventional configurations shown in FIG. 1. Since the particle scattering is fundamentally dipole radiation excited by the external field, the scattered light intensity is proportional to the external field intensity at the particle location. Therefore, the scattering of a particle on the Si surface is enhanced by the same factor of field enhancement.

In this invention, a deep ultra violet (DUV) laser illuminates a semiconductor wafer at a wavelength that creates total internal reflection within the lens to enhance the electric field at wafer surface. The illustrative example uses Si as the semiconductor wafer, in combination with a 266 nm laser.

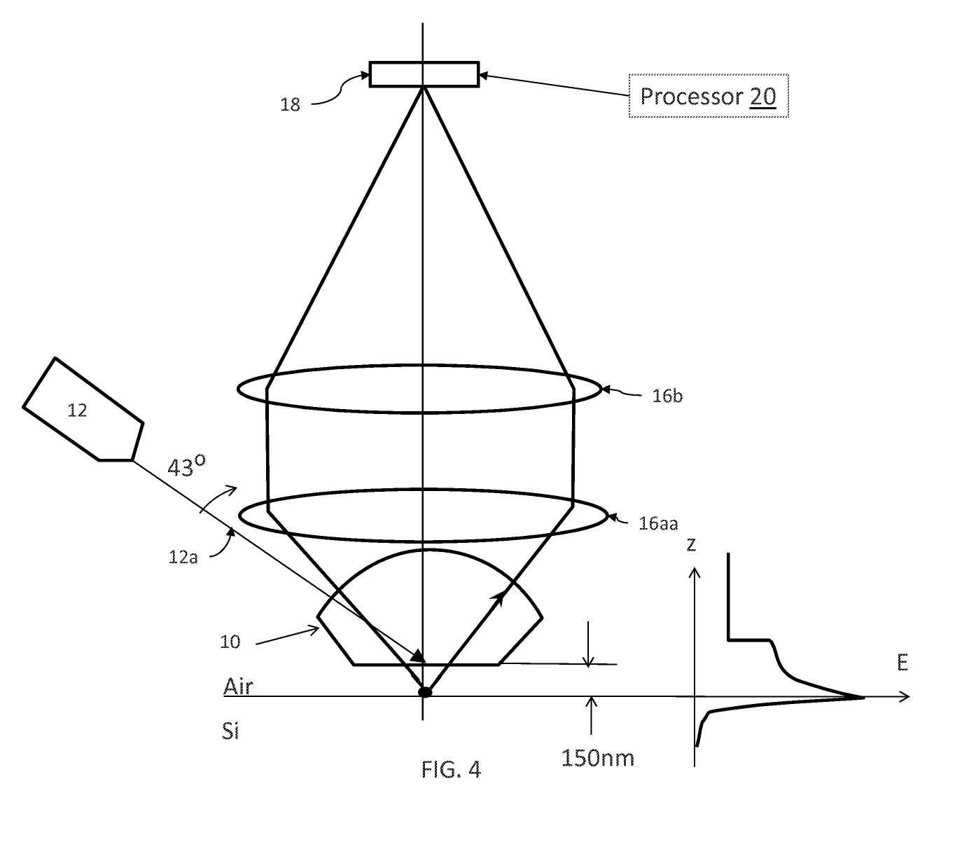

FIG. 4 illustrates a functional block diagram according to the invention. A solid immersion lens 10 made of SiO₂ is brought close to the Si surface, while the front flat surface of the lens 10a is parallel to the Si surface and the air gap is about 145 nm. A DUV light source 12 emits a laser beam 12a illuminates the surface through the solid immersion lens 10 at about a 43 degree angle from Si surface normal (for a hemisphere lens, the incident angle inside the glass is also 43 degrees). Since the air gap is less than the wavelength, an evanescent wave, generated at the interface between the front surface of the lens 10a and the Si surface, induces an enhanced electric field on Si surface. The solid immersion lens 10 is supported by a lens support 14 (not shown). Since the air gap is less than wavelength, the scattered light of the particle excited by the enhanced electric field is coupled by the solid immersion lens to the far field and collected by optional first and second lenses 16a, 16b. First lens 16a collimates the scattered light while second lens 16b focuses the collimated scattered on to the detector 18. The detector 18 detects the collected light and generates a corresponding detector signal. A processor 20 receives and analyzes the detector signal.

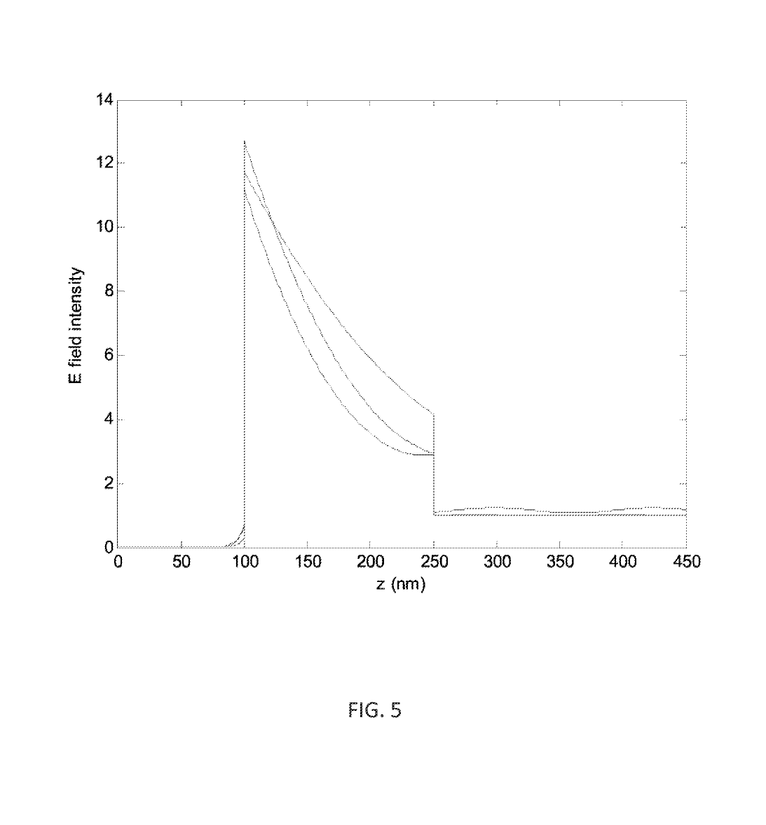

Suitable DUV light sources 12 include but are not limited to diode pumped solid state lasers with high order, for example, third and fourth harmonic conversions, e.g., from Newport Corporation or Coherent, Inc. A broadband light source emitting a wavelength as shown in FIG. 5 may be used. If needed, the light source may be combined with appropriate optics to generate a polarized illumination beam that is P-polarized.

The solid immersion lens 10 is preferably a hemispherical lens. A solid immersion lens obtains higher magnification and higher numerical aperture than common lenses by filling the object space with a high refractive index solid material. Other shapes of the element, e.g., aspherical or spherical, are possible as long as it has a first surface that can be brought close to the wafer surface with desired air gap and allows the incident beam to illumination the wafer from the glass ambient at the desired incident angle.

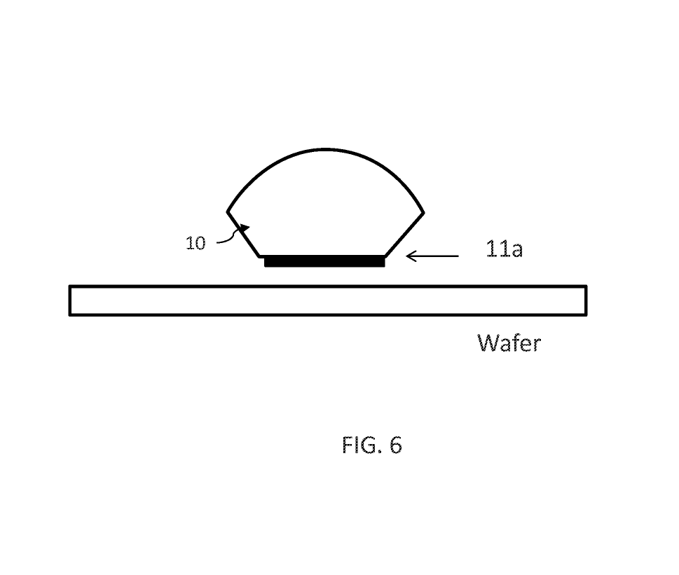

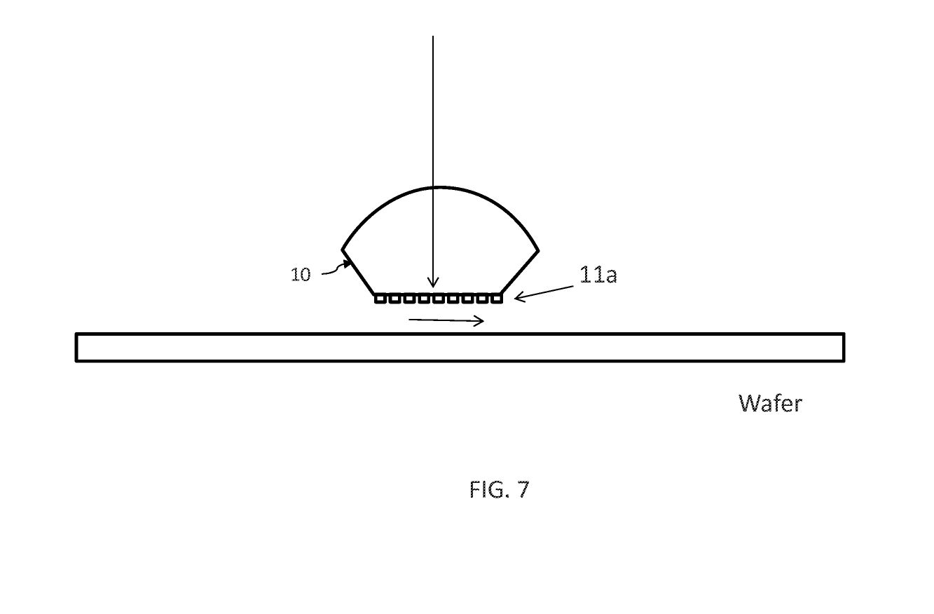

The optional metal coating 11a may be made of Ag, Au, or any other material that permits evanescent wave to be generated, as shown in greater detail in FIG. 6. Alternatively, a grating 11b may be applied to the lens as shown in FIG. 7. The grating profile and pitch can be designed such that for a given incident angle, one diffraction order is generated and its propagation direction is parallel the surface of the lens, and the grating material can be metal or dielectric. For Si wafer inspection, suitable lens material must be transparent at 266 nm.

In operation, the electric field at the wafer surface is enhanced, therefore scattering by particle is more efficient. The gain of scattering efficiency can be used for either improving particle sensitivity at given throughput or increasing throughput at a given sensitivity. The optics configuration is naturally compatible with solid immersion imaging, a solid immersion lens has higher magnification and higher numerical aperture than common lenses by filling the object space with a high refractive index solid material. Therefore, imaging resolution is also improved by a factor of the lens index, about 1.5× when SiO₂ material is used.

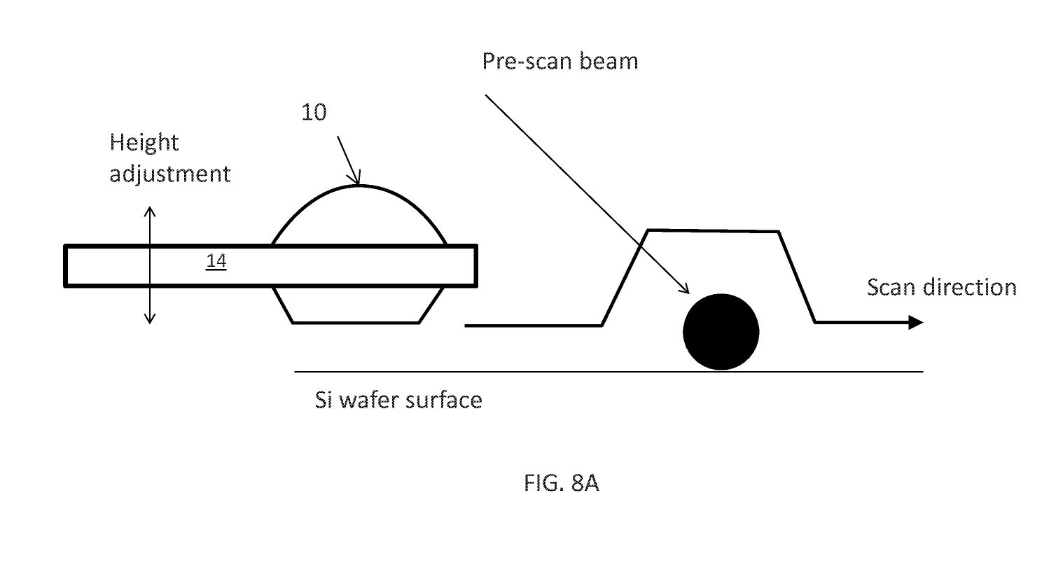

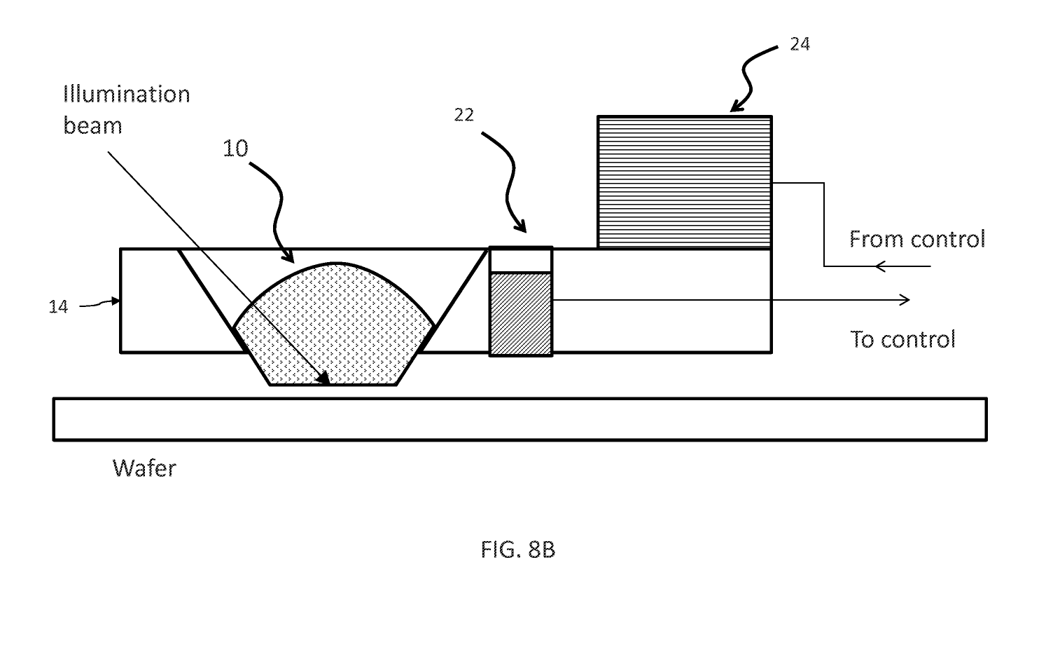

The lens support 14 positions the lens surface closest to the wafer within a range around the desired air gap as shown in FIG. 8A and FIG. 8B. FIG. 8A illustrates a pre-scan beam applied prior to inspection to avoid crashing onto larger particles. The larger particles can be easily detected by a laser illumination without field enhancement. The laser illumination field is ahead of the hemisphere lens in the scanning direction. When a large particle is detected, the hemisphere lens is lifted by a piezoelectric stage to a height greater than the particle height to jump over the large particle. FIG. 8B illustrates an active feedback control for the lens support. The lens support 14 houses the solid immersion lens 10 and a displacement sensor 22. A piezoelectric actuator 24 receives an electrical signal from the displacement sensor 22, which measures the air gap and is connected to the processor 20. The piezoelectric actuator 24 adjusts the height of the lens 10 according to the feedback of measured height from displacement sensor 22 to compensate for wafer height changes during scan therefore to maintain the desired distance for the air gap.

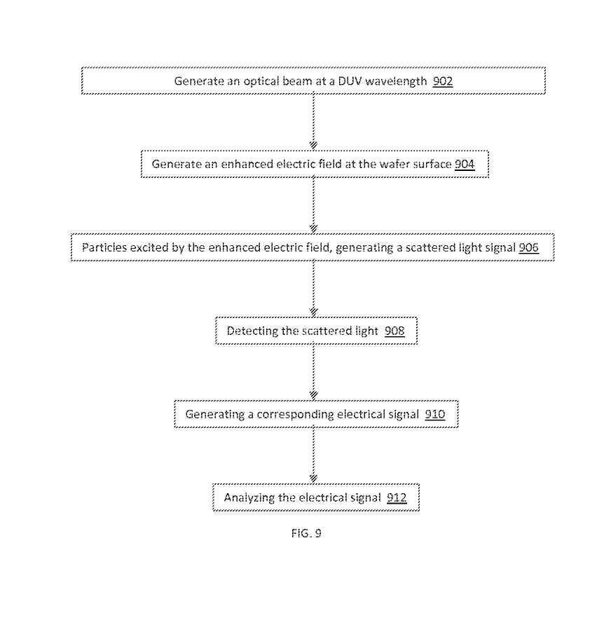

FIG. 9 illustrates a flowchart according to the present invention. In step 902, an optical beam is generated at a deep ultraviolet wavelength, ranging from 110 nm to 355 nm. In step 904, an enhanced electric field is generated at the wafer surface. In step 906, particles that are excited by the enhanced electric field generate a scattered light signal. In step 908, the scattered light signal is detected. In step 910, a corresponding electrical signal is generated. In step 912, the electrical signal is analyzed by setting a threshold that is higher than the background noise. Defects are identified as pulses that are higher than the set threshold. While DUV wavelengths are preferred, however, the same concept can be applied to other combinations of wavelengths and materials that are capable of generating enhanced electric field at sample surfaces.

Evanescent waves are formed when waves traveling in the solid immersion lens under total internal reflection at its boundary because they strike it at an angle greater than the critical angle. At critical angle illumination and at a proper air gap, an evanescent wave induces an enhanced electric field on the wafer surface. Particles excited by the enhanced electric field will generate a scattered light signal. When the scattered light signal is higher than the threshold, e.g., known good bare wafer signal, poor quality wafer is detected. An illustrative defect classification may be used in combination with the invention is disclosed in U.S. Pat. No. 8,532,949, “Computer-implemented Methods and Systems for classifying defects on a specimen”, assigned to KLA-Tencor, incorporated by reference herein. Individual defects detected on a wafer are assigned to defect groups based on one or more characteristics of the individual defects. Alternatively, the user may assign a classification to each of the defect groups.

While the concept is described for bare wafer inspections, it can also be extended to patterned wafer inspections such that imaging contrast on some patterned wafers that have patterns on Si may be improved. The invention provides a method and system for generating an enhanced electric field on wafer surface by utilizing evanescent waves, and thereby improves detection sensitivity of particle defects on a wafer surface.

What is claimed is:

1. A system for inspecting a surface of a wafer comprising:
a source generating an optical beam at a deep ultraviolet wavelength;
a solid immersion lens, receiving the optical beam, positioned such that the air gap between the lens and the wafer surface is less than the wavelength, an enhanced electric field being generated at the wafer surface, at least one particle on the wafer receiving the enhanced electric field generating scattered light;
a detector receiving the scattered light and generating a corresponding electrical signal; and
a processor receiving and analyzing the electrical signal.

2. The system as recited in claim 1, when the wafer is silicon, wherein the deep ultraviolet wavelength ranges from 150 nm to 355 nm.

3. The system as recited in claim 1, at least one objective lens interposing the solid immersion lens and the detector for collecting the scattered light.

4. The system as recited in claim 1, wherein the solid immersion lens is selected from a group including hemispherical, spherical, and aspherical lenses having a flat surface.

5. The system as recited in claim 4, including a metal coating on the surface of the lens proximate to the wafer.

6. The system as recited in claim 5, wherein the metal coating is selected from a group including silver and gold.

7. The system as recited in claim 4, including a grating on the surface of the lens proximate to the wafer.

8. The system as recited in claim 1, further including a first and a second lens interposing the solid immersion lens and detector, wherein the first lens collimates scattered light and the second lens focuses the scattered light on the detector.

9. A method for inspecting a surface of a wafer comprising:
generating an optical beam at a deep ultraviolet wavelength, wherein an air gap separating the wafer and a lens is less than the wavelength;
at the wafer surface, generating an enhanced electric field from the optical beam;
generating a scattered light signal when particles on the wafer receive the enhanced electric field;
detecting the scattered light signal;
generating a corresponding electrical signal; and
analyzing the electrical signal.

10. The method recited in claim 9, wherein the deep ultraviolet wavelength ranges from 150 nm to 355 nm.

11. The method recited in claim 9, further comprising scanning the wafer for large particles prior to generating optical signal.

12. The method recited in claim 9, further comprising analyzing the electrical signal including comparing the electrical signal to a threshold, wherein the threshold is indicative of wafer quality.

13. The method recited in claim 9, further comprising:
collimating the scattered light; and
focusing the scattered light on a detector.
